(19) United States
(12) Patent Application Publication
(10) Pub. No.: US 2012/0211922 A1
(43) Pub. Date: Aug. 23, 2012

(54) DEVICE FOR PROCESSING RAPID POLYMERIC REACTION SYSTEMS

(75) Inventors: Joachim Wagner, Koln (DE); Michael Gladisch, Bergisch Gladbach (DE); Hubert Ehbing, Odenthal (DE); Thomas Herweg, Wipperfurth (DE); Jürgen Gollan, Bergisch Gladbach (DE)

(73) Assignee: Bayer Material Science Ag, Leverkusen (DE)

(21) Appl. No.: 13/389,174

(22) PCT Filed: Jul. 24, 2010
(86) PCT No.: PCT/EP2010/004553

§ 371 Date: May 8, 2012

(30) Foreign Application Priority Data
Aug. 7, 2009 (DE) 10 2009 036 505.2

(51) Int. Cl. B29C 45/13; B01J 19/26; B01J 19/18

(52) U.S. Cl. 264/328.8; 425/130; 422/135

(57) ABSTRACT

The invention relates to a device for machine-based processing of rapid polymeric reaction systems, particularly polyurethane systems, wherein a rapid formula change is possible with simultaneously low raw material consumption. The device according to the invention further requires little space, allowing for operation in a standing flue, for example.

The present invention relates to a device for the machine-based processing of rapid polymeric reaction systems, especially polyurethane systems, in which a quick change of formulation is desired while the consumption of raw material is low.

When new materials are developed, properties of different formulations must be tested. The critical point is a rapid screening of many different compositions.

The processing of rapidly reacting polymeric products, especially polyurethane products, occurs, for example, in reaction injection molding (RIM). The corresponding devices contain all elements of a chemical reactor.

The two main components, which are polyol and polyisocyanate in the case of polyurethane, are transferred from storage tanks into working vessels. In the working vessels, the raw materials are brought into a processable condition. This primarily means an exact temperature control, since each temperature change brings about a change in viscosity. This may lead to problems in the downstream processing process, or in altered material properties of the product. However, it is also possible to effect individual formulations from different raw material supply containers via premixing stations, or to mix additional components, such as activators, stabilizers, foaming agents or flame retardants, with the respective components, and to fill these mixtures into the working vessels. In order to keep the components in a processable condition, they must be temperature-controlled and homogenized. Accordingly, the working vessels are mostly equipped with heating and cooling jackets. In another frequent solution, separate temperature-controlling circuits leading through heat exchangers provide for the exact observance of the desired processing temperatures. The possible equipment also includes homogenizing agitators as well as automated refilling systems, filling level, pressure and temperature indications.

Now, dosage aggregates convey the components from the working vessels to the mixing head in an exactly defined mixing ratio. This is where the reaction partners come together and are combined to form the reaction mixture.

Depending on the polyurethane system to be processed, precision dosage aggregates with different feeding rates and pressure ranges are required. Basically, they must meet all high and highest standards for the dosing precision for observing the stoichiometry. In addition to conventional gear pumps and in-line piston pumps, axial piston pumps have also proven useful.

In general, a distinction is made between two processing methods: low pressure (LP) and high pressure (HP) methods.

While in the LP method, pressures within a range of from 3 to 40 bar are applied to the component flows, the HP method operates at pressures of the components within a range of from 100 to 400 bar. The mixing of the components in the LP method is effected by agitated mixing chambers or with static mixers; in the HP method, the components are mixed according to the countercurrent injection principle: the high kinetic energy of the component flows that has been generated is utilized for mixing when the flows enter the mixing chamber.

In the LP method, the two raw material components are usually circulated through the mixing head before being mixed in the low pressure range, i.e., at 3 to 40 bar. When the “shot” is triggered, mixing head nozzles are opened under positive control and synchronically, releasing the components in the required mixing ratio into the mixing chamber. For example, a corresponding LP mixing chamber consists of a hollow cylinder with an intensive agitator, from which the reaction mixture is discharged after the mixing. The agitator must be cleaned from remaining masses of the reaction mixture on a regular basis, for example, by rinsing liquids. Although this is done automatically, cleaning down times of the low pressure machine are unavoidable. The low pressure processing is preferably employed in polyurethane processing plants with substantially continuous operation (e.g., flexible block foam production).

It is also known to mix the components directly by a static mixer; the advantage of this method resides in the fact that no moving machine parts are necessary for the mixing. The drawbacks of this method reside in the tedious cleaning procedure for the static mixer and the fact that this kind of mixer is always filled with polymer that is reacting. Therefore, an interruption of the dosing is always accompanied by either the production of rejects or the clogging of the mixer. To avoid these drawbacks, disposable plastic mixers may be employed, such as those sold, for example, by the company Agens Stratmann, Oelde, or the WEKEM GmbH, Werne. However, this results in another drawback. High feed pressures cannot be realized for reasons of mechanical stability of the mixer.

In the HP method, the components are initially pressurized under high pressure of 100 to 400 bar, which is referred to as “compressed” in the following; then, dosage aggregates convey this material under the prevailing operating pressure to the mixing head and, according to the prior art, recycle it back into the working vessels through a release valve. When the “shot” is triggered, a control piston in the mixing head is withdrawn and thereby synchronically enables access of the compressed components to the mixing head nozzles. The polyol and isocyanate components hit each other in the mixing chamber under 200 bar, for example, and are mixed thereby. When the predefined product quantity has been shot in, the control piston closes the mixing head nozzles and thus opens the way again for the recirculation of the unreacted components; due to the exact guidance of the plunger, the mixing chamber is automatically cleaned, i.e., the reaction mixture that has not yet left is conveyed from the mixing chamber without residues. Additional cleaning agents are not required. High pressure machines can be utilized to higher capacity as compared to low pressure machines since cleaning down times are almost completely avoided.

The dosing of the components in the correct stoichiometric ratio must be reproducible in both methods and must be effected with high precision. Therefore, only precision dosage aggregates are applied.

When the formulation are changed, the raw material tanks and the circulation conduits are to be cleaned completely in both the LP and the HP production method, which is not really a problem in the industrial production, because such product changes are comparatively rare. However, this change of formulation is very frequent for such processes in development laboratories, in part several times a day. This is a significant disadvantage for the use of such machines.

The preparation of polymeric products in the reaction injection molding process is known in the prior art (see, for example, Reinhard Leppkes: Polyurethane, “Die Bibliothek der Technik”, 5th Edition, Volume 91, pp. 23 to 27, Verlag Moderne Industrie 1993, or Ullmann's Enzyklopädie der Technischen Chemie, 4th Edition, Volume 19, pp. 316 to 317, Verlag Chemie, Weinheim 1980).

A number of manufacturers offer the corresponding devices. The commercially available devices for use in the reaction injection molding process have shot volumes within a range of from 16 to 50 cm³ and total volumes in a range of up to several hundreds of liters.

In addition to large scale processing, machines for use on the pilot plant scale with smaller shot volumes are also known. Both the VARIO-MIX® plant from Hilger and Kern and the PSM 3000 polyurethane high-pressure plant from the Isotherm AG are suitable for small shot volumes. However, the PSM 3000 from Isotherm has a footprint of 15 m² and is thus difficult to employ in the usual laboratory setting. The pressure build-up is effected by hydraulic pistons. Both plants have long supply and circulation conduits from the working vessels to the mixing chamber, and thus large conduit volumes. The drawbacks of this design for a frequent change of formulation have been mentioned above.

Those and other modern small scale processing machines for the laboratory or pilot plant scale usually work with one channel each for raw material supply and two pressure pistons working in tandem, and thus have a large raw material requirement and a large material-containing pipeline to be cleaned. Due to the designs of the machines with raw material circuits, a raw material quantity within a range of at least 10 kg is necessary. A rapid change of formulation is not possible here, since the cleaning of the conduits and of the mixing head are correspondingly time-consuming.

An economically efficient screening of new materials is not possible here, since on the one hand there is a high consumption of raw materials that are present in the conduits. Further, the high time demand during the cleaning when the formulation is changed is also a cost factor.

Thus, the object of the present invention is to provide a device for the reaction injection molding of polymeric reaction systems with a low raw material requirement and small footprint. In particular, the raw material requirement per component is to be less than 200 ml per component. A rapid change of formulation should be possible, which also means that it should be possible to perform the cleaning of the device quickly and simply. It should be possible to perform such a change of formulation within a period of less than 60 min. The results obtained must be reproducible and up-scalable to the industrial scale. The injection mold should have an area within a range of DIN A5 size and a thickness of about 2 to 10 mm. At the same time, a corresponding device should have a small footprint in order that operation in the laboratory is possible, for example, in a walk-in hood.

The object of the present invention is achieved by a device in which at least two components are processed by machine under high pressure. In such a device, the at least two components are mixed in a mixing head under high pressure with only one pressure piston each and optionally several working vessels per raw material channel for compressing the respective components.

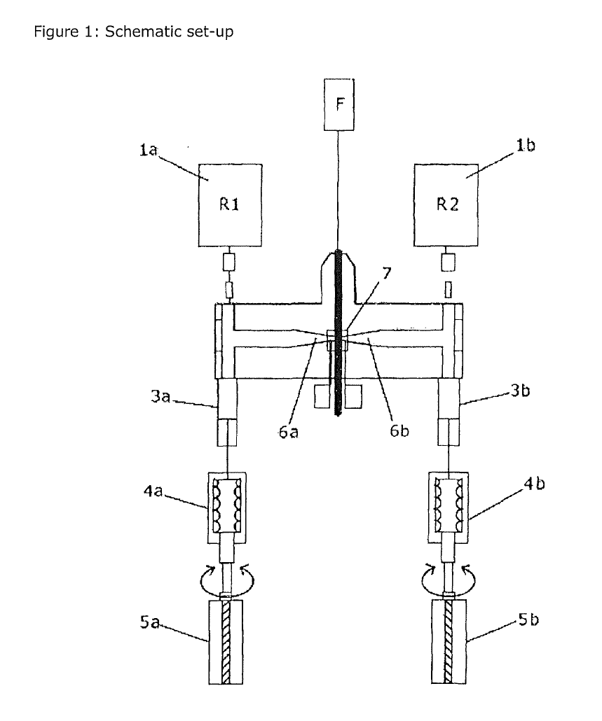

A possible set-up is schematically shown in FIG. 1. A device according to the invention includes working vessels 1a and 1b, which contain the reaction components R1 and R2, respectively. In addition to compressed air, the working vessels 1a and 1b can also be pressurized with alternative inert gases (pressure range 0-10 bar) in order to avoid air bubble inclusions in the reaction components R1 and R2. Between the working vessels la and lb and the mixing aggregate, there are spring-reset sop valves 9a and 9b (normally open), which are actuated electrically or pneumatically, and can be pressurized with 0-10 bar on the primary side and 0-400 bar on the secondary side. The build-up of the pressures in the pressure pistons 3a and 3b is respectively realized by electrically driven linear motors 5a and 5b, which compress the raw material solutions in the pressure pistons 3a and 3b through a mechanical energy storage system with disc springs 4a and 4b. Through injection nozzles 6a and 6b, the components get into the mixing chamber 7 and from there into the mold F. The central zone of the device, consisting of the mixing chamber 7 and the injection nozzles 6a and 6b, is shown as an enlarged section within FIG. 1.

In a device according to the invention, the pressure pistons 3a and 3b and the working vessels la and lb are in close proximity to the mixing head. This ensures that the conduit volume does not exceed 5 cm³ per raw material channel. When the mixing head 7 is closed, the respective raw material flows from the working vessel la or lb into the respective pressure pistons 3a and 3b, where it is compressed after the stop valves 9a and 9b are closed. By repeated cycles of filling and discharging the raw material components into the respective raw material supplies, any air that may be in the system is pressed out of the conduits and into the working vessels. Thus, the conduits and the working vessels and thus the later final product as well are free from air inclusions. If needed, however, specific gases, or even air, can be incorporated into the raw materials through agitators with suitable agitator blades, and homogenized under pressure up to a maximum of 10 bar already in the supply vessel. This allows for the preparation of foamed end products.

The pressurization of the liquid raw material in the pressure pistons 3a and 3b is effected by means of electrically driven linear motors 5a and 5b. Due to the use of electric motors, the space requirements of the whole apparatus are reduced. Hydraulically working pressure pistons as known from the prior art have clearly increased space requirements.

According to the invention, the pressurization of the liquid raw material is effected through coupled mechanical energy storage systems 4a and 4b, which consist of disc springs in the present concrete design. The raw material is compressed to a pressure within a range of from 100 to 400 bar in pressure piston 3a or 3b, respectively, the disc springs storing energy for the initial phase of the dosage. Thus, they provide for a substantially constant pressure already in the initial phase of the dosage until the dosage proceeds with a constant movement.

The withdrawal of the mixing chamber press-out plunger in the mixing chamber 7 during the dosage period opens the raw material channels and leads to high-pressure mixing of the reaction partners, followed by discharging the reacting material into mold F. The moving of the mixing chamber press-out plunger can be alternatively effected electrically or pneumatically.

The introduction of the raw material components into the mixing chamber is effected through nozzles 6a and 6b. These nozzles are in line, or the apertures for the nozzles in the mixing head are opposite to one another. The nozzles are respectively formed as an annular nozzle by a screen and a centrally positioned conical needle. The nozzle cross-sections (change of the annular gap) can be adjusted from the outside before and also during the mixing process by changing the depth of penetration of the conical needle. Such adjustment can be done both manually and electronically. This allows for exact adaptation of the mixing pressure and dosage flow rate. Correspondingly attached sensors for the pressure in the working vessel, the pressure in the pressure pistons, the mixing pressure, the piston position, the product temperatures and mixing temperatures allow for detailed monitoring of the processing process. In addition, a transmission of the sensor data to the PC at intervals of a few milliseconds enables the reaction to be controlled even during the reaction.

The mixing head itself preferably has exclusively linear channels. These allow for a simple cleaning of the mixing head from the outside by metal dies without a time-consuming disassembly. All the feed lines of the mixing head are in a plane. The actual mixing chamber is a cylindrical insert, which can also be prepared as a plastic component simply and at low cost. This insert is fixed to the mixing head by means of screws and can be removed simply by undoing these screws. Thus, it is possible to change the mixing chamber without problems when the formulation is changed. For example, a mixing chamber according to the invention has a mixing volume of about 2 to 3 mm³, the total volume up to the transition of the mixing chamber into the mold including the supply needle being ≦15 mm³. Due to the small conduit volumes, the required raw material volume is ≦200 cm³ per component.

The working vessels is and lb, the pressure pistons 3a and 3b and the mixing head can be temperature-controlled independently of one another. Thus, it is possible to heat up the raw materials to a temperature of up to 80° C. Similarly, the mold, which is moved or connected to the outlet of the mixing head, can be heated to a temperature of up to 130° C. It is also possible to shoot a reaction mixture into a suitable open container rather than a mold. For example, this enables control to be exerted with respect to the reactivity and mixing quality, color, viscosity and homogeneity of a formulation under the processing conditions that have been set.

The device according to the invention enables the processing of reactive components with cream times in a range of from 0.5 s to far above 100 s. The dosage times may vary from 0.3 to 20 s, wherein the precision of the dosing times may be one millisecond, for example. Higher dosage times can be realized simply if needed. Raw materials having a viscosity of from 1 to 10,000 mPa·s can be processed, for example, wherein the output rate may be within a range of from 100 g/s to below 0.5 g/s.

The raw material components are introduced into the mixing chamber, for example, in a high pressure countercurrent at 100 to 400 bar. Due to short linear conduits and operation under high pressure, the time requirements for a change of formulation can be kept low. Such a change can be done within a timeframe of about 15 to 30 min. In addition, the device according to the invention has a small footprint of about 2 m². Thus, in a laboratory, the device according to the invention, which can be easily displaced, for example, by means of rolls, could be accommodated in a walk-in hood.

The control and survey of the device is effected electronically by a connected PC and programmable logic controller (PLC) connected thereto. A simple operation is possible by a touchscreen. All sensor parameters can be continuously monitored, and the process parameters regulated if necessary, by means of corresponding programs. The product temperatures and the mold temperature can also be controlled accordingly.

1-15. (canceled)

16. A device for the machine-based processing of polymeric reaction systems with at least two components under high pressure with only one pressure piston each and optionally several working vessels per raw material channel for compressing the respective components, and a mixing head, characterized in that the conduit volume between the pressure piston and the mixing head is ≦5 cm³ per raw material channel.

17. The device according to claim 16, characterized in that electric linear motors compress the liquid raw materials present in the pressure pistons.

18. The device according to claim 17, characterized in that said electric linear motors compress the raw materials through a mechanical energy storage system.

19. The device according to claim 18, characterized in that said mechanical energy storage system comprises disc springs.

20. The device according to claim 16, characterized in that the raw materials in the pressure pistons are each compressed to a pressure within a range of from 100 to 400 bar.

21. The device according to claim 16, characterized in that all feed lines in the mixing head are in a plane, and the injection nozzles through which the raw materials enter the mixing head are arranged in line.

22. The device according to claim 21, characterized in that the nozzle cross-sections can be adjusted manually or electronically.

23. The device according to claim 16, characterized in that said mixing head exclusively has linear channels.

24. The device according to claim 23, characterized in that said mixing chamber includes a plastic lining.

25. The device according to claim 16, characterized in that said mixing head has a mixing volume of ≦15 mm³ including the needle.

26. The device according to claim 16, characterized in that the required volume of raw materials per component is 200 cm³ or less.

27. The device according to claim 16, characterized in that the working vessels can be temperature-controlled up to a temperature of 80° C.

28. The device according to claim 16, characterized in that the mold can be temperature-controlled up to a temperature of 130° C.

29. The device according to claim 16, characterized by comprising a control system by which the mixing pressure, piston displacement and pressure build-up in the mold can be surveyed and controlled during the reaction.

30. A process for preparing polymeric molded parts by an RIM process using a device according to claim 16.
